(19) United States
(12) Patent Application Publication
(10) Pub. No.: US 2023/0402629 A1
(43) Pub. Date: Dec. 14, 2023

(54) Metal Hydride Fuel Sources For Vehicle Operation and Pressure-Based Control Systems and Methods

(71) Applicant: BATTELLE SAVANNAH RIVER ALLIANCE, LLC, AIKEN, SC (US)

(72) Inventors: Henry Thomas SESSIONS, AIKEN, SC (US); Andrew J. BLANTON, AIKEN, SC (US); Patrick A. WARD, AIKEN, SC (US); Scott C. MCWHORTER, EVANS, GA (US)

(21) Appl. No.: 18/177,363

(22) Filed: Mar. 2, 2023

Related U.S. Application Data
(60) Provisional application No. 63/351,151, filed on Jun. 10, 2022.

(51) Int. Cl. H01M 8/04082; H01M 8/0438; H01M 8/04701; H01M 8/04014; H01M 8/0432; B64U 50/32; C01B 3/00

(52) U.S. Cl. CPC H01M 8/04216; H01M 8/04425; H01M 8/04738; H01M 8/04014; H01M 8/04373; B64U 50/32; C01B 3/0026; C01B 3/0084; H01M 2250/20

(57) ABSTRACT

Disclosed are systems and methods that utilize a solid hydrogen storage material, e.g., a metal hydride as a fuel source for operating a vehicle. Disclosed systems utilize the pressure of a hydrogen storage tank as a controlling factor for release of hydrogen from a solid hydrogen storage material. Disclosed systems are particularly beneficial for use with unmanned aerial vehicles.

### CROSS REFERENCE TO RELATED APPLICATION

This application claims filing benefit of U.S. Provisional Patent Application Ser. No. 63/351,151 entitled “Metal Hydride Fuel Sources for Vehicle Operation and Related Systems and Methods,” having a filing date of Jun. 10, 2022, which is incorporated herein by reference for all purposes.

### FEDERAL RESEARCH STATEMENT

This invention was made with Government support under Contract No. 893033210EM000080, awarded by the U.S. Department of Energy. The Government has certain rights in the invention.

### BACKGROUND

Electric motors are highly beneficial for use in vehicles as they are two to three times more efficient than gas-powered internal combustion engines, they emit no undesirable emissions, and they are quiet and vibration free. Electric motors in vehicles are generally powered by batteries, but unfortunately, the weight and recharging times for batteries still limits broad adoption. Particularly in aerial vehicles, such as unmanned aerial vehicles (UAV), the weight and energy capacity of current energy storage devices, primarily lithium ion batteries, limits both flight time and payload. For instance, conventional battery-powered UAVs have a typical flight time of 20 or 30 minutes. As a result, conventional UAVs can only be operated for short periods of time before they need to be recharged.

Hydrogen fuel cells have been examined for use in powering electric motors of vehicles, including UAV as hydrogen gas (H₂) has a higher specific energy than conventional lithium-ion batteries. The specific energy of diatomic hydrogen gas is 32.4 Wh/g, while the specific energy of lithium-ion batteries ranges from 0.100 to 0.265 Wh/g. Hydrogen fuel cells can extend travel time between recharging as compared to electric motors powered with batteries, but still present significant issues. A major drawback to the wider utilization of hydrogen as a vehicle fuel remains the lack of acceptable hydrogen storage mediums and adequate control of the hydrogen during use. Conventionally, hydrogen has been stored in the gas phase under high pressure or in the liquid phase at extremely low temperatures. Unfortunately, high-pressure hydrogen storage vessels are bulky, heavy, and pose a safety concern, particularly if considered for use in vehicles, and low temperature liquid phase storage is challenging for use in electric-powered vehicles, considering the issues of durable insulation materials and managing liquid boil-off (i.e., dormancy).

Accordingly, systems and methods that provide an alternative for storing and providing hydrogen for use in operating a vehicle (e.g., a UAV) would be welcomed in the technology.

### SUMMARY

According to one embodiment, disclosed is a hydrogen fuel cell system. The system includes a fuel vessel that is configured to retain a solid hydrogen storage material, e.g., a metal hydride. The system also includes a hydrogen storage tank in fluid communication with the fuel vessel. The system also includes a pressure sensor that is configured to monitor a hydrogen pressure within the hydrogen tank. The system also includes a heater that is configured to heat the solid hydrogen storage material. A heater controller is in communication with the pressure sensor and the heater such that the hydrogen pressure within the hydrogen tank is a controlling factor for the operation of the heater. In addition, the system includes a fuel cell in fluid communication with the hydrogen tank.

Also disclosed are methods for powering an electric motor, e.g., a vehicle motor such as may be utilized in a UAV. A method can include retaining a solid hydrogen storage material in a fuel vessel. The method can also include transmitting information regarding a pressure within a hydrogen tank to a controller, and based upon the information, the controller powering or refraining from powering a heater that is in thermal communication with the solid hydrogen storage material. Upon powering of the heater, hydrogen is released from the solid hydrogen storage material and flows from the fuel vessel to the hydrogen tank. The method can also include controlling a flow of hydrogen from the hydrogen tank to a fuel cell and powering an electric motor by use of a current flow generated in the fuel cell.

### BRIEF DESCRIPTION OF THE FIGURES

A full and enabling disclosure of the present subject matter, including the best mode thereof, directed to one of ordinary skill in the art, is set forth in the specification, which makes reference to the following figures.

FIG. 1 schematically illustrates one embodiment of a system as disclosed herein.

FIG. 2 schematically illustrates one embodiment of a fuel cell as may be incorporated in a system.

FIG. 3 schematically illustrates one embodiment of a segmented fuel vessel as may be incorporated in a system.

FIG. 4 is a photograph illustrating a UAV utilized in examples described further herein.

FIG. 5 is a photograph illustrating an alane vessel utilized in examples described further herein.

FIG. 6 is a photograph illustrating the results of a burst test on a vessel as illustrated in FIG. 5.

FIG. 7A illustrates ceramic heaters as may be utilized in a system as described

FIG. 7B illustrates the top side of a ceramic heater.

FIG. 7C illustrates the bottom side of a ceramic heater.

FIG. 7D illustrates a ceramic heater following soldering of connector pins to the heater leads.

FIG. 7E illustrates a heater attachment for attaching the heater to a fuel vessel electrical feedthrough.

FIG. 7F illustrates a ceramic heater following covering of the electrical contacts with a high temperature epoxy.

FIG. 8A is a photograph illustrating an alane puck on a ceramic heater.

FIG. 8B is a photograph illustrating the height of two alane pucks as utilized in examples described further herein.

FIG. 9A is a photograph illustrating a heater in the bottom of a fuel vessel.

FIG. 9B is a photograph of the fuel vessel of FIG. 9A following insertion of a fuel puck into the vessel.

FIG. 9C is a photograph of the fuel vessel following locating of insulation around and on top of the fuel pucks.

FIG. 10 is a photograph of a fuel vessel including a pressure relief device installed thereon.

FIG. 11A is a photograph illustrating a fuel vessel.

FIG. 11B is 75a photograph illustrating the top of a fuel vessel.

FIG. 11C is a photograph illustrating the top of a fuel vessel.

FIG. 12 is a photograph illustrating a test system as described in the Examples section.

FIG. 13 is a photograph illustrating a test system as described in the Examples section.

FIG. 14 is a photograph illustrating the test system in flight.

FIG. 15 illustrates the two alane fuel pucks following the flight.

FIG. 16 graphically illustrates the hydrogen tank pressure and fuel cell power during a UAV flight described in the Examples section.

FIG. 17 is a photograph illustrating a bench test experimental set up described herein.

FIG. 18 illustrates the interior of a fuel vessel used in a UAV testing protocol.

FIG. 19 is a photograph illustrating a bench top testing system described herein.

FIG. 20 is a photograph illustrating two heaters used to heat a fuel source during a UAV flight test.

FIG. 21 is a photograph illustrating a UAV test system during flight.

FIG. 22 illustrates a fuel cell reconditioning cycle voltage, current, power, and regulator pressures.

FIG. 23 graphically illustrates the fuel cell efficiency change between reconditioning cycles (790-800 W loading range).

FIG. 24 illustrates results of the 800 W hydrogen fuel cell bench test before reconditioning. Trial 1, from time t=360 to 786 s average power 798.6 W, Eff 34.65%.

FIG. 25 illustrates results of the 800 W hydrogen fuel cell bench test after reconditioning twice. Trial 2, from time t=146 to 816 s average power 790.1 W, Eff 39.43%.

FIG. 26 illustrates results of the 800 W hydrogen fuel cell bench test after reconditioning four times. Trial 3, from time t=101 to 331 s average power 793.0 W, Eff 41.48%.

FIG. 27 illustrates results of the 800 W hydrogen fuel cell bench test after reconditioning six times. Trial 4, from time t=618 to 874 s average power 790.7 W, Eff 40.23%.

FIG. 28 illustrates results of the 800 W hydrogen fuel cell bench test after reconditioning eight times. Trial 5, from time t=169 to 659 s average power 797.8 W, Eff 39.64%.

FIG. 29 illustrates results of the 800 W hydrogen fuel cell bench test with the alane vessel valve open at time 559 s. Loaded to approximately 784 W.

FIG. 30 illustrates results of a 800 W hydrogen fuel cell bench test with alane and heater system (single heater).

FIG. 31 illustrates results of a 800 W hydrogen fuel cell bench test with alane and heater system (single heater). Thermocouple placement on outside surface of the alane puck.

FIG. 32 illustrates results of a 800 W hydrogen fuel cell bench test with alane and heater system (single heater).

FIG. 33 illustrates results of a 800 W hydrogen fuel cell bench test with alane and heater system (single heater). Thermocouple placement on outside surface of the alane puck.

FIG. 34 illustrates the hydrogen gas pressure and fuel cell output power from a UAV test flight utilizing alane as fuel with a single heater. The UAV takeoff weight was 24.5 lbs.

FIG. 35 illustrates the hydrogen gas pressure and fuel cell output power from a UAV test flight utilizing alane as fuel with a single heater. Time and pressure scales were adjusted for analysis of system after the check valve opened.

FIG. 36 illustrates the hydrogen gas pressure and fuel cell output power from a UAV test flight utilizing alane as fuel with two heaters.

FIG. 37 illustrates the hydrogen gas pressure and fuel cell output power from a UAV test flight utilizing alane as fuel with two heaters. Time and pressure scales were adjusted for analysis of system after the check valve opened.

FIG. 38 illustrates the change in wt. % and ion intensity after the second (two heater) alane flight. Data was taken at puck 1, center, on the heater side.

FIG. 39 illustrates the change in wt. % and ion intensity after the second (two heater) alane flight. Data was taken at puck 2, center, on the heater side.

FIG. 40 illustrates the change in wt. % and ion intensity after the second (two heater) alane flight. Data was taken at puck 1, at the outside edge of the puck, on the heater side.

FIG. 41 illustrates the change in wt. % and ion intensity after the second (two heater) alane flight. Data was taken at puck 2, at the outside edge of the puck, on the heater side.

### DETAILED DESCRIPTION

Reference now will be made in detail to embodiments of the invention, one or more examples of which are illustrated in the figures. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present subject matter relates generally to hydrogen storage systems and hydrogen fuel cell systems incorporating the hydrogen storage systems as well as to methods that can benefit from the hydrogen storage systems. More specifically, disclosed are systems that can utilize a metal hydride as a hydrogen storage material and that can efficiently provide hydrogen as a fuel to a fuel cell as can be used for operating a vehicle, such as a UAV. In another aspect, one or more embodiments of the disclosed systems and/or methods can use hydrogen provided from a solid hydrogen storage material as the primary, secondary, or only source of hydrogen to a fuel cell that can be used for powering a vehicle. For instance, a system may include a container that houses a solid hydrogen storage material, a heater, and a hydrogen storage tank to supply hydrogen to a fuel cell, e.g., a proton exchange membrane (PEM) hydrogen fuel cell that can be used to power a vehicle, e.g., a UAV.

Presently, batteries are the most common form of power for UAVs. However, hydrogen fuel cells, e.g., proton exchange membrane (PEM) hydrogen fuel cells have been developed for use in vehicles including UAVs. Presently, PEM hydrogen fuel cells are supplied hydrogen from small, compressed gas cylinders carried by the vehicle. The presently disclosed systems and methods allow for hydrogen to be supplied to a fuel cell from a solid hydrogen storage material, e.g., alane. Through incorporation of solid hydrogen storage materials using disclosed control systems, the disclosed system can deliver more than three times the amount of hydrogen in a volumetrically equivalent as compared to a compressed gas cylinder containing hydrogen.

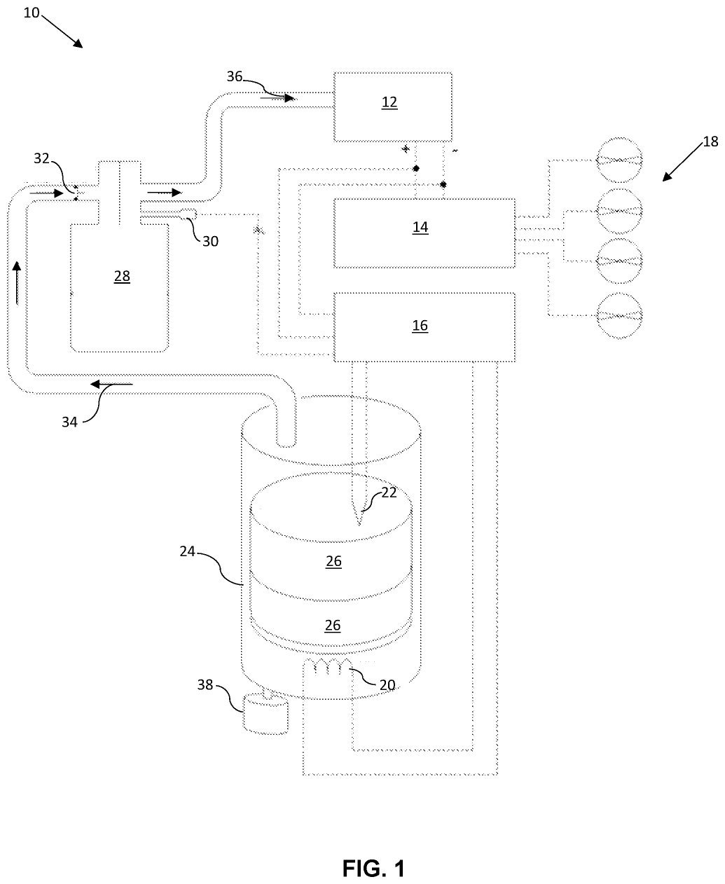

FIG. 1 is a schematic representation of one embodiment of a hydrogen fuel cell system as described herein. As illustrated, the hydrogen fuel cell system includes a fuel vessel 24 that is configured to contain one or more solid structures 26 that include a solid hydrogen storage material.

A solid structure 26 can provide for storage of hydrogen in the solid phase through inclusion of a solid hydrogen storage material. The storage of hydrogen in the hydride form can provide a greater volumetric storage density than hydrogen storage as a compressed gas or a liquid and can present fewer safety problems than hydrogen stored in a gas or a liquid phase, particularly as desorption can be well controlled. The hydrogen storage materials can provide a high power density, e.g., about 0.5 watt-hour/gram (W-h/g) or higher and can do so at a low weight density, e.g., about 3 gram/cubic centimeter (g/cc) or less; for instance, from about 0.5 g/cc to about 3 g/cc, or from about 1.7 g/cc to about 2.7 g/cc in some embodiments.

It should be appreciated that, although the present subject matter will generally be described with reference to the use of alane as a solid hydrogen storage material, any suitable solid material capable of sorbing/desorbing hydrogen may be used in accordance with aspects of the present subject matter. Additionally, it should be appreciated that, although the present subject matter will generally be described with reference to powering a hydrogen fuel cell-powered unmanned aerial vehicle (UAV) or drone, the disclosed systems and methods may be used to power any suitable vehicle, including various other types of fuel cell powered vehicles and/or other vehicles that can be powered using a hydrogen fuel cell.

In one embodiment, the hydrogen storage material can sorb and release hydrogen through reversible formation of a metal hydride bond according to an interstitial hydride formation. Interstitial hydrides are traditionally termed ‘metal hydride compounds’ even though they do not strictly conform to the definition of a compound. They more closely resemble alloys such as steel, and as such, are commonly described as incorporating the hydrogen via ‘metal bonding.’ In interstitial metal hydrides, hydrogen can exist as either an atomic or diatomic entity and the hydride is formed by the absorption and insertion of hydrogen into the crystal lattice of the metal, metal alloy, or a phase of the metal alloy. The interstitial hydride systems can be non-stoichiometric and able to incorporate variable amounts of hydrogen atoms in the lattice, and as such, their absorption capacity can vary greatly between materials and conditions.

In one embodiment, the hydrogen storage material can include an aluminum-based hydrogen storage material, i.e., an alanate such as, and without limitation to alane (aluminum hydride, AlH₃), lithium alanate (LiAlH₄), sodium alanate (NaAlH₄), magnesium alanate (Mg(AlH₄)₂), calcium alanate (Ca(AlH₄)₂), or any mixtures thereof.

In one embodiment, the hydrogen storage material can include, without limitation, an element chosen from Group IA alkali metals, Group IIA alkali earth metals, Group IIIB lanthanides, or Group IVB transition metals. In one embodiment, the hydrogen storage material can include a transition metal capable of forming a reversible binary metal hydride including, without limitation, palladium, titanium, zirconium, hafnium, zinc, and/or vanadium.

Multi-component metal alloys are also encompassed as solid hydrogen sorbing/desorbing materials and can include, without limitation, combinations of Group IV elements with Group V through Group XI elements (based on the 1990 IUPAC system in which the columns are assigned the numbers 1 to 18), as well as alloys including combinations of lanthanides (atomic numbers 58 to 71) with Group VII through Group XI elements. For example, the solid hydrogen storage material can have the structure AₓT_{y} in which A can be one or more Group IV elements and T can be one or more Group V through Group XI elements. In some embodiments, a Group VI metal can be selected from Mo and W, and a Group VIII metal can be selected from Fe, Co, Ni, Pd, and Pt. In some embodiments, a Group VI metal can be Mo and a Group VIII metal can be selected from Co and Ni.

In another embodiment, solid hydrogen storage material can have a compositional formula of

A₁₋ₓMₓT_{5-y-z}B_{y}C_{z},
wherein:
   A=is an alloy of rare earth elements, typically including cerium and lanthanum;
   M=La, Pr, Nd or Ce;
   T=Ni;
   B=Co;
   C=Mn, Al or Cr;
   x=0.0 to 1.0;
   y=0.0 to 2.5; and
   z=0.0 to 1.0.

Exemplary hydrogen storage materials can include, without limitation, lithium hydride (LiH), sodium hydride (NaH), potassium hydride (KH), beryllium hydride (BeH₂), magnesium hydride (MgH₂), calcium hydride (CaH₂), strontium hydride(SrH₂), titanium hydride (TiH₂), boron hydride (BH₃), lithium borohydride (LiBH₄), sodium borohydride (NaBH₄), magnesium borohydride (Mg(BH₄)₂), calcium borohydride (Ca(BH₄)₂), one or more alanates as mention previously, or any combination of hydrogen storage materials as are known in the art.

The hydrogen storage material can be selected to have a desired lattice structure and thermodynamic properties so as to control the pressure and/or temperature at which hydrogen is absorbed and desorbed. Such working thermodynamic parameters can be modified and fine-tuned by an appropriate alloying method according to known methodologies.

The solid structure 26 including the hydrogen storage material can include one or more additives that can improve desirable characteristics of the material, e.g., thermodynamic characteristics, kinetic characteristics, hydrogen absorption density, power density, activation energy, heat transfer, strength characteristics, etc. For example, additives that can be incorporated in a solid structure 26 including a hydrogen storage material can include, without limitation, palladium, titanium, titanium oxide, titanium fluoride, scandium, zirconium, nickel, cobalt, manganese, iron, vanadium, silicon, iron oxide, platinum, ruthenium, or combinations of additives. In some embodiments, a solid structure can include a binder, e.g., a graphite binder such as expanded natural graphite, or the like. When included, additives can generally be present in a solid structure 26 in an amount of up to about 10 wt. % of the solid hydrogen storage material.

The bulk form of the hydrogen storage material in the solid structure 26 can provide a high surface area for sorption/desorption of hydrogen. In embodiments, a solid structure 26 can include a porosity for increased hydrogen uptake and release kinetics of the hydrogen storage material. A porous solid structure 26 including a hydrogen storage material can increase the hydrogen flow within the structure 26 and can improve hydrogen sorption/desorption of a structure 26. The pore size can be selected/tuned as desired to affect hydrogen storage capacity and kinetics, as well as thermal stability. For instance, formation of a hydrogen storage material with smaller pores can provide a material with larger surface areas of interaction at the gas/solid interface. Pore size is not particularly limited and can be on a nanometer or a micrometer scale. For instance, in one embodiment, a hydrogen storage material can define pore sizes of from about 0.001 mm to about 1.0 mm.

In some embodiments, a solid hydrogen storage material can be in the form of a particulate including the solid hydrogen storage material, e.g., alane particles. A particulate including a solid hydrogen storage material can generally be on a micrometer or a nanometer scale. However, no particular particulate size is required when utilizing a solid hydrogen storage material provided in the form of a particulate.

In some embodiments, a particulate solid hydrogen storage material can be processed so as to minimize the volume of the storage material in a fuel vessel 24 while providing the hydrogen storage material in a hydrogen-accessible form. By way of example, in some embodiments, a particulate can be provided in a compressed, solid puck form, i.e., with the solid hydrogen storage material particles bonded or sintered to one another to provide a solid, porous puck from which hydrogen can be released without destruction of the solid structure 26. In such an embodiments, it may be beneficial to include an amount of a binder to encourage bonding of the individual particles of the structure 26.

In some embodiments, a hydrogen storage material can be provided in a solid structure in the form of a metal foam that can include a series of interconnected pores. A metal foam can exhibit relatively high porosity, e.g., about 75% to about 95% of the total volume of the metal foam can be void space. A metal foam can also provide a relatively strong solid structure 26 while providing the hydrogen storage material at the nano- or microscale. This can be beneficial in some embodiments as hydride materials can decrepitate or break down into smaller particles under repetitive reaction cycles, and high recyclability can allow for long life and reusability of a solid structure 26.

Referring again to FIG. 1, a fuel vessel 24 can be configured to contain a single solid structure 26 or a plurality of individual solid structures 26, e.g., a plurality of stacked solid structures 26 as illustrated in FIG. 1. In some embodiments, one or more solid structures 26 can be isolated from one another, for instance in separate pressure-controlled vessels. By way of example, in one embodiment as illustrated in FIG. 3, a pressure vessel 124 can include a plurality of pressure-isolated segments 125 that can each retain one or more solid structures that include a solid hydrogen storage material. As illustrated, each segment 125 can include an outlet 134 by which hydrogen can flow out of the isolated segment 125.

In conjunction with the solid structure(s) 26 that includes the solid hydrogen storage material, a system can include a pressure relief valve 38, a heater 20 and a heater controller 16 by which release of hydrogen from the solid structure 26 can be controlled. Any suitable heater 20 and associated heater controller 16 are encompassed herein. By way of example, a ceramic heater, heating cartridges, heat transfer fluids from another heat source, inductive heating targeting a conductor or additive in the material, or the like can be utilized. In general, a heater controller 16 can be a pressure-integral-differential (PID) controller, which is the most common type of industrial control in use today, but this is not a requirement of disclosed systems. PID controllers are available from several companies in a variety of form factors.

A system can include a single heater 20 or a plurality of heaters 20. For instance, a single ceramic heater 20 can be utilized that can be located in thermal contact with a solid structure 26 and thereby heat the structure 26 and encourage release of hydrogen from the solid hydrogen storage material. In other embodiments, a plurality of individual heaters or heating elements can be in thermal contact with a single solid structure 26, and the individual heaters or heating elements can operate simultaneously or individually. As utilized herein, the term “heating element” generally refers to a single element of a heater at which point electric energy is utilized to produce an increase in temperature.

In those embodiments in which a system is configured to retain multiple solid structures 26, individual solid structures of a system can be heated by use of a single heater 20 or by use of multiple heaters 20 (or heating elements). For instance, in an embodiment as illustrated in FIG. 1, in which a fuel vessel 24 is configured to retain multiple structures 26 in a stacked arrangement, the system can include a single heater 20 for heating all of the structures 26 or alternatively, can include multiple heaters, one or more of which is in thermal contact with each of the individual structures 26 within the fuel vessel 24. Likewise, in those embodiments in which a system includes a segmented fuel vessel as in FIG. 3, each segment 125 can include one or more heaters and/or heating elements for heating one or more structures that include a solid hydrogen storage material retained within each segment 125.

In addition to one or more heaters 20 in thermal communication with the solid hydrogen storage material of a system, a system can also monitor the temperature of the solid structure(s) 26 of a system by use of a thermocouple 22. As indicated, a thermocouple 22 can be in communication with the heater controller 16 of a system. As is known, a solid hydrogen storage material will generally release hydrogen within a known temperature range. For instance, alane will begin to release hydrogen beginning at a temperature of about 80° C. with all hydrogen released by a temperature of about 200° C. Through inclusion of a thermocouple 22 in thermal communication with the solid hydrogen storage material, a system can monitor the material for the amount of stored hydrogen still available for release in the solid hydrogen storage material. As the temperature of the solid structure(s) 26 approach the upper temperature for hydrogen release from the particular hydrogen storage material used in the system, the heater controller 16 can be configured to limit power to the heater 20 and prevent over-heating of the system. Moreover, upon such a situation, the system can be configured to switch to an alternative power source, e.g., a battery back-up and/or return the vehicle to the base.

Upon release of hydrogen from a solid hydrogen storage material retained within a fuel vessel 24, the released hydrogen can flow 34 from the fuel vessel 24 to a hydrogen storage tank 28. The hydrogen storage tank 28 can be a pressure vessel configured to retain hydrogen at high pressure. For instance, the hydrogen storage tank 28 can safely retain hydrogen at pressures of about 5,000 psig in some embodiments. The hydrogen storage tank 28 can be sized for the particular type of vehicle to be powered by the system. For instance, when considering a UAV, a hydrogen storage tank 38 can be relatively small, e.g., about 5 liters or less, such as about 4 liters or less, about 3 liters or less, or about 2 liters or less, such as from about 0.5 liters to about 3 liters in some embodiments.

The hydrogen storage tank 28 includes a pressure sensor 30 that is configured to monitor the pressure within the hydrogen storage tank 28. As indicated, the pressure sensor 30 is in communication with the heater controller 16. During use, the heater controller 16 can be programmed to utilize the pressure within the hydrogen storage tank 28 as a controlling factor for powering the heater 20 of the fuel vessel 24 as well as a feedback signal for on-going control of the heater 20. By way of example, a hydrogen storage tank 28 can be filled with hydrogen prior to use of the system. During use, as the hydrogen in the storage tank 28 is fed 36 to the fuel cell 12, the pressure within the tank 28 will decrease. At a predetermined pressure, e.g., about 1000 psig or less, about 500 psig or less, such as from about 200 psig to about 500 psig, the heater controller 16 can turn on the heater 20, upon which the temperature of the hydrogen storage material retained within the solid structures 26 will be released. Depending upon the rate of the hydrogen release from the solid structure, when the pressure within the hydrogen storage tank rises to a cut-off level, the heater controller 16 can shut down the heaters 20 until the pressure within the hydrogen storage tank 28 again falls to the predetermined pressure and the heater 20 is again turned on. Hydrogen from the hydrogen storage tank 28 can thus be continually provided at the desired pressure in a flow 36 to the fuel cell. In some embodiments, and depending upon the triggering on/off pressures, the heating of the solid structures 26 can continue throughout the use of the system or until the hydrogen held within the structures 26 is depleted.

In other embodiments, the hydrogen storage tank 28 need not be pre-filled with high pressure hydrogen, and hydrogen released from the fuel vessel 24 can provide all hydrogen for the system during use. For instance, the heater controller 16 can initiate heating of the structures and upon attainment of a predetermined hydrogen pressure within the hydrogen storage tank 28, a signal can be provided to initiate hydrogen flow 36 to the fuel cell and current flow to the controller 14 and motors 18 of a vehicle, e.g., the propellers of a UAV.

In some embodiments, the fuel cell 12 can also be utilized to power the heater controller 16 and the heater 20. In other embodiments, these components of a system can be separately powered, such as by use of a battery.

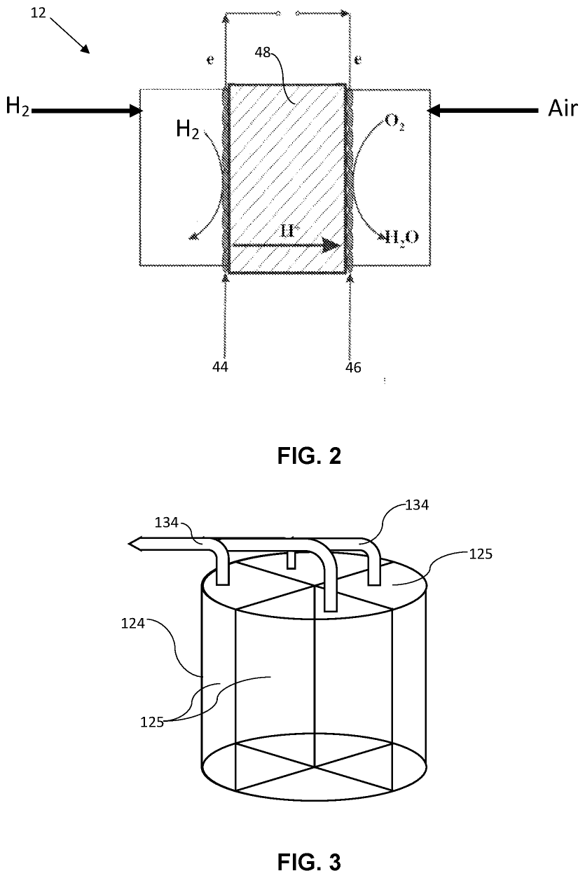

The hydrogen fuel cell 12 can be any suitable cell design and type. In general, and as illustrated in FIG. 2, a hydrogen fuel cell can include an anode 44 and a cathode 46 with an electrolyte 48 that allows proton flow therebetween. The anode 44 receives hydrogen gas from the hydrogen storage tank 28 and the cathode 46 receives oxygen, generally from air, as shown. The hydrogen gas is dissociated at the anode 44 to generate free protons and electrons. The protons pass through the electrolyte 48 to the cathode 46, where they are reduced and react with oxygen to generate water. The electrons are directed from the anode 44 through a load (e.g., the vehicle motor) to perform work before being sent to the cathode 46.

In one embodiment, a hydrogen fuel cell 12 can include a solid polymer electrolyte proton conducting membrane, such as a perfluorosulfonic acid membrane. The anode 44 and cathode 46 typically include finely divided catalytic particles, for instance platinum (Pt), supported on carbon particles and mixed with an ionomer. The catalytic mixture is deposited on opposing sides of the membrane. The combination of the anode catalytic mixture, the cathode catalytic mixture, and the membrane define a membrane electrode assembly (MEA).

A vehicle can include several individual fuel cells 12 combined in a fuel cell stack to generate the desired power. In some embodiments, a fuel stack can also include cooling flow channels through which a cooling fluid can flow for temperature control. In those embodiments in which a system includes multiple individual fuel cells 12 in a stack, a single hydrogen storage tank 28 can provide hydrogen to one or multiple individual fuel cells of the stack 12.

The present invention may be better understood by reference to the Examples set forth below. One of ordinary skill in the art will readily appreciate that the present subject matter may be advantageously applied across various other different implementations or embodiments.

### Example 1

A PEM hydrogen fuel cell, supplied with hydrogen from alane, AlH₃, was used to power a UAV. The typical flight time using batteries was 20 to 30 minutes. Calculations showed that the combination of a fuel cell and hydrogen from one kilogram of alane could increase flight times to approximately 150 minutes (i.e., 2.5 hours).

A commercially available fuel cell-powered UAV, supplied with compressed hydrogen from a cylinder, was obtained. A test flight with the UAV, as purchased, lasted only one minute. Thereafter, several modifications were made to the UAV. The arms supporting the motors were lengthened to move props further away from the center of the UAV to prevent propwash. The landing gear was lengthened to accommodate the fuel cell and fuel vessel, and a bracket was designed and 3D printed to attach the hydrogen cylinder and fuel cell to the UAV. New motor mounts were designed and 3D printed that accommodated the motor, landing gear, and support arm. The modified UAV is shown in FIG. 4.

Following modifications, three test flights were conducted (two on one day and a third flight a week later) using a fuel cell supplied with hydrogen from a 1.5-liter compressed gas cylinder. The flights lasted 54, 48, and 53 minutes. The slightly shorter 48-minute flight was because some testing was performed on the ground before flight. These test flights demonstrated a stable flight platform and provided flight training.

The 1.5-liter cylinder contained hydrogen compressed to 4,500 psig. This equates to 34 grams of hydrogen. Alane contains approximately 10 wt. % hydrogen. 1 kilogram of alane contain 100 grams of hydrogen or approximately 3 times the amount of hydrogen that was needed and used to fly our UAV for the 52-minute average flight times. (3×52=156 minutes of flight time.)

Following the successful flights with compressed hydrogen, preparations were made for a flight using alane. 50 grams of alane was chosen as a standard amount to be used. This was dictated by the quantity of alane and equipment available to compress the alane into a compact size (puck) for increased density and improved heat transfer. Subsequently, once the quantity, geometry, and size of the alane puck was determined, a vessel was designed to house the alane (FIG. 5).

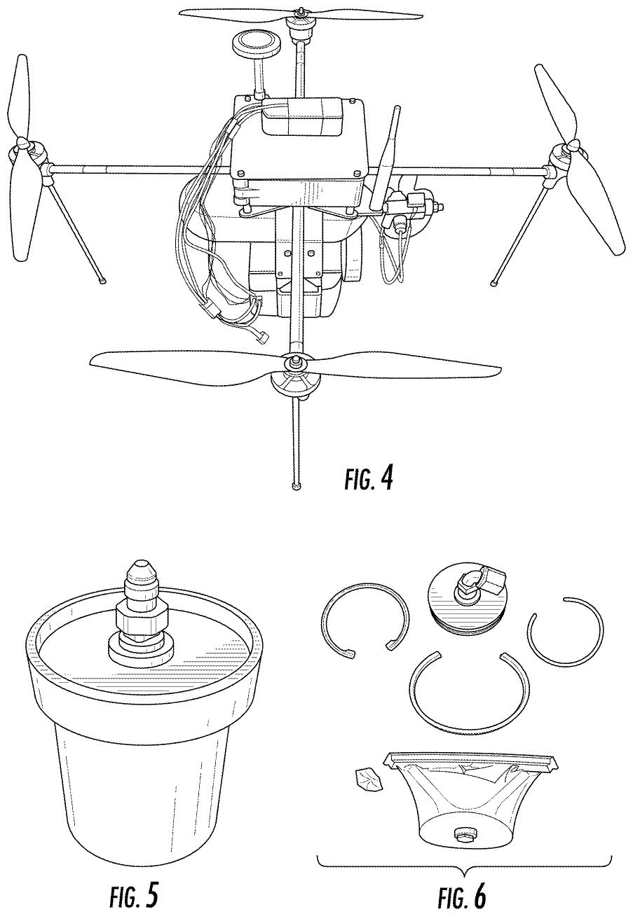

Heating the alane to release hydrogen leads to a corresponding pressure increase in a closed vessel. Therefore, the vessel must be able to safely contain this pressure. To prove that the design is safe, the vessel was tested to destruction (i.e., burst test). For purposes of the testing, it was determined that the vessel must be able to withstand 4 times the maximum working pressure. FIG. 5 presents a photograph of the vessel and FIG. 6 illustrates results of the burst test. The burst test was conducted showing the viability of the tank and material.

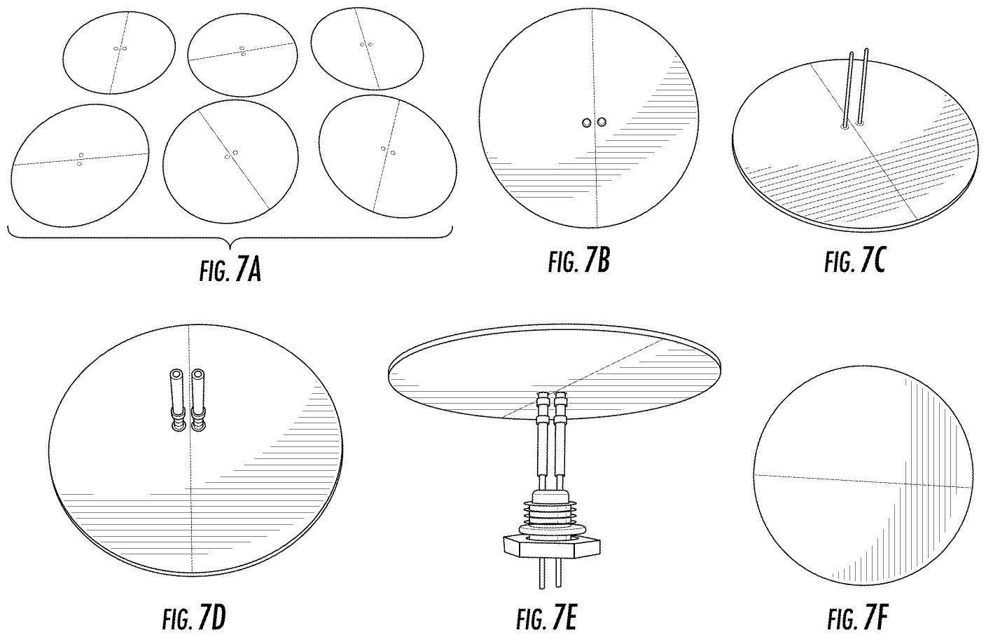

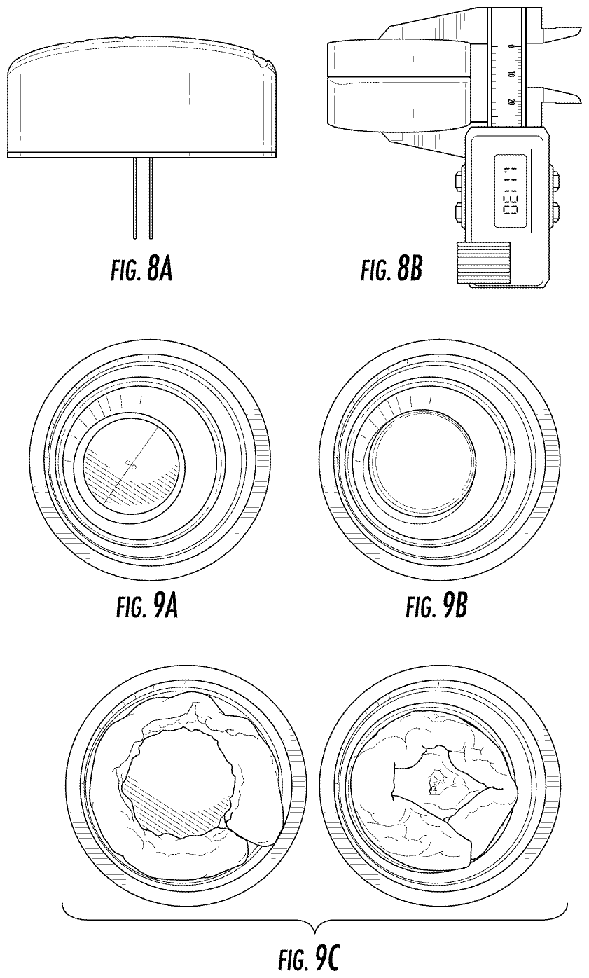

A heater was designed and manufactured to comply with the specified heater dimensions and power requirement. The heater was two inches in diameter and produced approximately 109 watts with 24-volt input. Photographs of the heater are shown in FIG. 7A-7F including FIG. 7A, which illustrates several ceramic heaters utilized in the systems. FIG. 7B illustrates the top side of a ceramic heater and FIG. 7C illustrates the bottom side of a ceramic heater. FIG. 7D illustrates a ceramic heater following soldering of connector pins to the heater leads. FIG. 7E illustrates a heater attachment for attaching the heater to a fuel vessel electrical feedthrough. FIG. 7F illustrates a ceramic heater following covering of the electrical contacts with a high temperature epoxy.

To increase density and improve heat transfer of alane used in the system, the alane fuel material was pressed into a puck (FIG. 8A). The pressed puck was two inches in diameter, approximately one half of an inch thick, and weighed approximately 25 grams. Expanded Natural Graphite (ENG) was added to the alane as a binder. It had no effect on alane, but it did reduce the overall percentage of hydrogen per gram of puck since ENG contains no hydrogen. The ENG was made from crushed coconut shells. Two pucks were used for each flight (FIG. 8B) and their combined weight was approximately 50 grams and they contained 9.104 weight % hydrogen (i.e., 4.5 grams hydrogen).

FIG. 9A illustrates a fuel vessel following insertion of a heater (arrow) in the bottom of the vessel. The pucks were stacked inside the alane vessel on the heater (FIG. 9B). One major concern was the ability to heat both pucks with only a single heater placed at the bottom of one puck; however, this was proven not to be an issue. Alane must be heated to 200° C. to release all the hydrogen. Evolution of hydrogen begins at a lower temperature, close to 80° C. Therefore, the rate of heating controls the rate of hydrogen released. This release is slightly endothermic. If heat is removed, release of hydrogen stops. Additionally, more energy is required in the later stages of hydrogen release. These are the characteristics of alpha phase alane, a hexagonal close-packed crystalline structure, which is the desired stable structure. Alane is stable in air because of a surface oxide layer that acts as a kinetic barrier to decomposition. Breaking this barrier with heat is required to release hydrogen.

As hydrogen is released from alane it becomes activated aluminum. Aluminum is an excellent heat transfer medium. Therefore, heat is readily transferred from the bottom of the puck to the top of the puck as hydrogen is released. Electrical resistance of one of the pucks prior to hydrogen release was measured to be 5,000 ohms. After the hydrogen was released, the resistance was measured to be only one tenth (0.1) of an ohm. The alane transformed from an insulator into a conductor upon release of hydrogen. For this reason, a high temperature epoxy was placed over the two electrical contacts that were exposed on the ceramic heater (FIG. 7F). Without this added insulation, the ceramic heater would have short-circuited after initial release of hydrogen.

An additional assistance in heat transfer was the hydrogen itself. Hydrogen has a high thermal conductivity. As it flowed from the bottom of the alane towards the top, it transferred heat.

The formation of activated aluminum upon hydrogen release from alane, the high thermal conductivity of hydrogen, and the release of hydrogen being slightly endothermic, were all benefits with respect to controlling the release of hydrogen. Also, the alane pucks retained their shape during hydrogen release, which further aided in control of hydrogen release.

The heater was installed in the vessel (FIG. 9A), alane pucks placed on top of the heater (FIG. 9B), and Kaowool® insulation used to surround and cover the pucks (FIG. 9C). Hydrogen flowed readily out of the alane pucks and through the porous insulation.

Although the vessel had been burst tested to prove adequate design, a pressure relief device was included in the design for additional personnel safety. Therefore a “Code Certified” pressure relief device was installed on the alane vessel (FIG. 10).

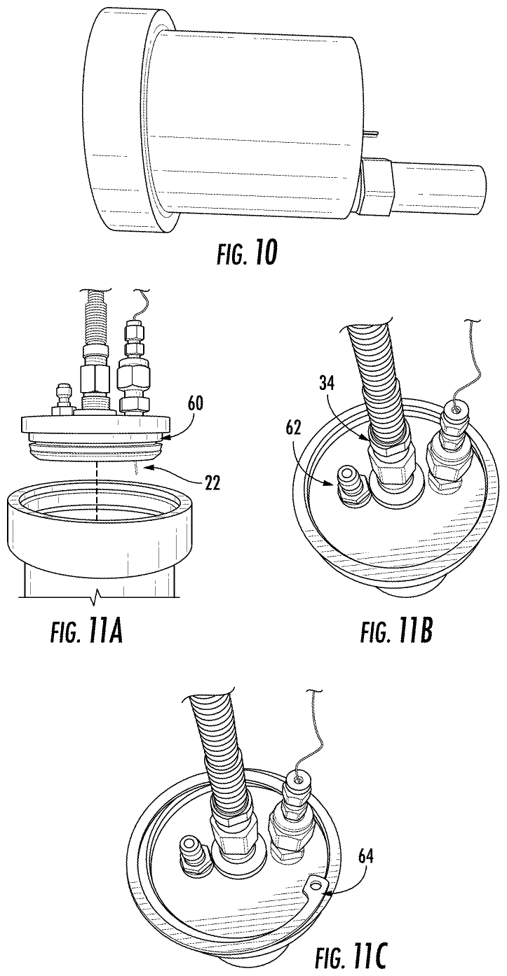

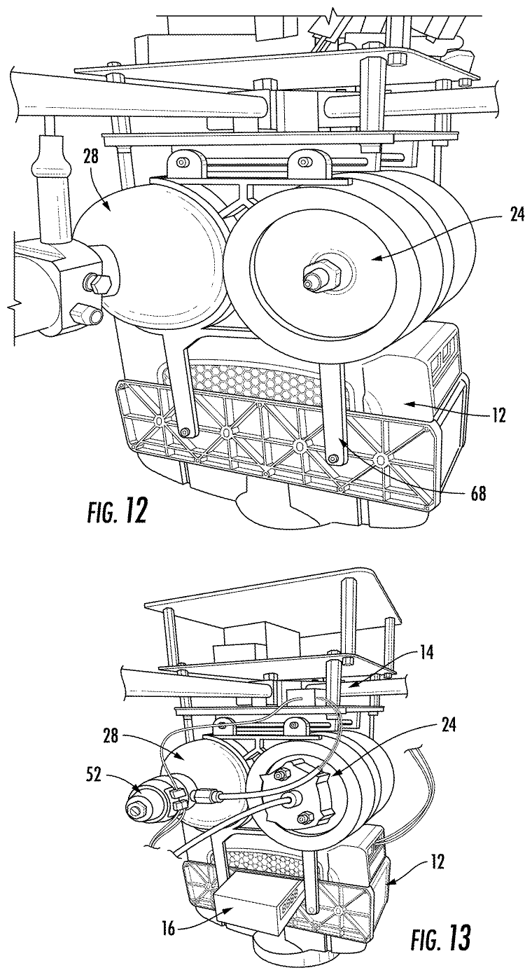

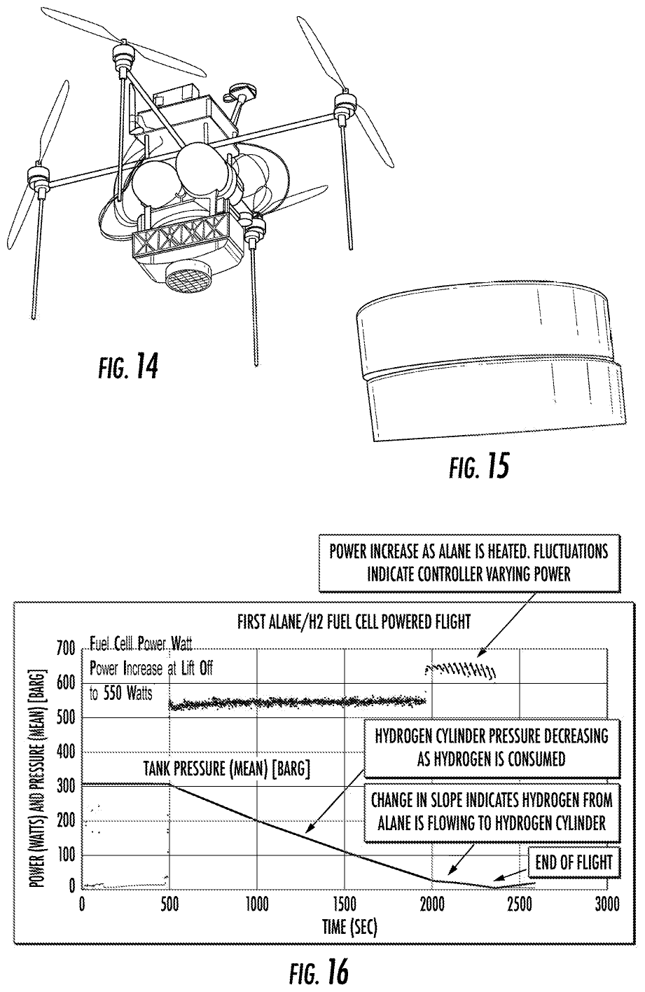

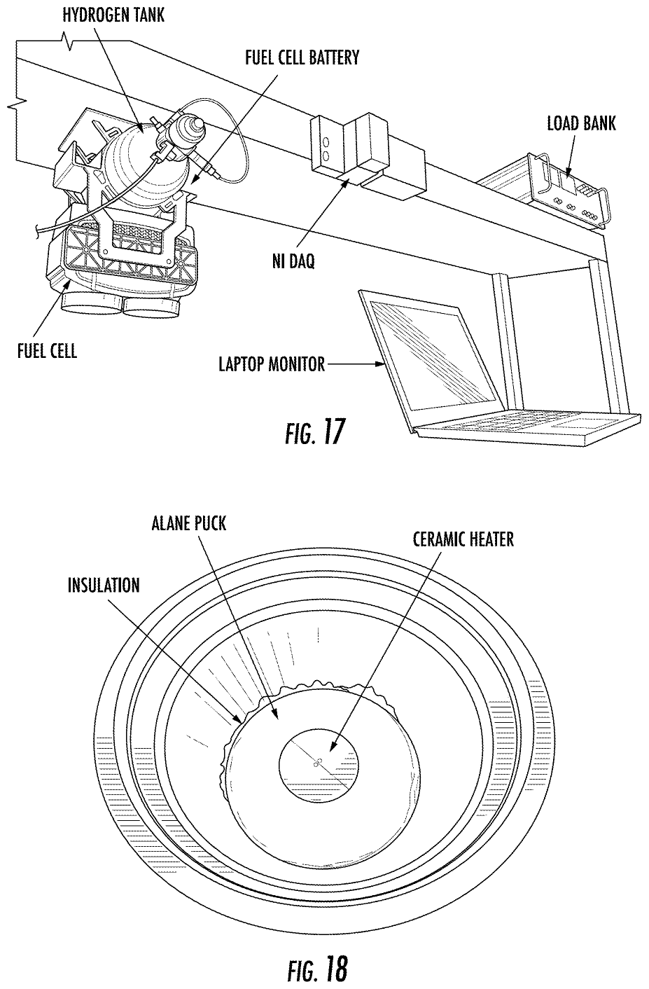

FIGS. 11A, 11B, and 11C illustrate the top of the fuel vessel. The alane fuel vessel needed to be light weight and sufficiently strong to contain the pressure of the evolving hydrogen gas. It had to be leak tight, able to withstand the temperature required to heat the alane to 200° C., provide easy access to load the two-inch diameter pucks and have both gas ports and electrical feedthrough.

The vessel was made from aluminum with wall thickness adequate to withstand the required pressure. An electrical feedthrough that could withstand both temperature and pressure was also installed. A Swagelok fitting was modified to be a feedthrough to allow a thermocouple 22 to contact the top of the alane while maintaining a leak tight gas seal. A large opening with an ‘O″ ring seal 60 was designed and fabricated to facilitate access for installation of the heater, alane, and insulation. Gas ports with fittings were installed. A removeable retainer ring 64 was used for both structural integrity and easy removal of the top flange. Burst tests proved the integrity and design of the vessel. In FIG. 11A can be seen the thermocouple 22 and the O-ring 60 for sealing the lid upon assembly. In FIG. 11B the line hydrogen outlet flow 34 and the check valve 62 are shown.

With the limited amount of alane available, the flight time was calculated to be only 5.2 minutes. Therefore, it was decided to fly with both compressed hydrogen and hydrogen from alane to feed the fuel cell. Once the compressed hydrogen was consumed, alane would supply supplemental hydrogen to extend the flight time. A small battery was needed to start the fuel cell and act as very short-term emergency power source (sufficient for immediate landing) if the fuel cell failed.

In order to conserve weight and accommodate all required components a smaller one-liter hydrogen cylinder was used. As illustrated in FIG. 12, the system included a bracket 68 designed to house the one-liter hydrogen tank 28, the alane fuel vessel 24, and the fuel cell 12. The alane vessel 24 was also insulated externally to reduce heat loss and to protect other components. Tests conducted with the insulated alane vessel 24 showed only a slight rise above ambient temperature on the outer surface of the insulation.

The ceramic heating element was also powered by the fuel cell. Thus, the fuel cell supplied power for flight as well as for heating the alane. The nominal fuel cell power was 650 watts at 24 volts and had the capability of supplying 1,000 watts for a short duration. Previous flight tests showed that power for flight required 550 watts. The heater requires 100 to 109 watts. Therefore, the fuel cell was used at its maximum capacity.

The fuel cell required a low pressure for operation, (7 to 10 psig) with a hydrogen flow rate of 8 to 10 liters per minute. A pressure regulator on the hydrogen cylinder regulated the pressure and incorporated a pressure transducer and filling port equipped with a check valve. The fuel cell was automatically turned off once the pressure in the hydrogen cylinder dropped below 75 psig to protect the fuel cell. Fuel starvation causes corrosion of the fuel cell's carbon substrates and degrades fuel cell performance.

Prior to attaching the alane vessel to the UAV, the vessel was evacuated and backfilled with hydrogen. This was repeated three times to purge any trapped air. A check valve 42 identical to the one on the hydrogen cylinder was used to prevent air in-leakage. During assembly, the alane fuel vessel 24 and the compressed hydrogen tank 28 were attached in a manner to maintain center of gravity of the UAV and prevent issues with propwash maintain the light weight of the system. A bracket 68 was designed and 3-D printed with light weight polymers. The bracket mounted underneath the flight controller and the bracket had adjusting slots to aid in moving the load to the center of gravity. Additionally, the alane fuel vessel 24 and hydrogen tank 28 could be moved independently.

The complete testing system is shown in FIG. 13. The system was configured to use the pressure signal from the hydrogen cylinder pressure regulator 52 to determine when to automatically start heating the alane in the fuel vessel 24 and then as a feedback signal for heater control 16. The heater control 16 utilized a PID control loop. A commercially available heater controller was chosen that could be operated on 24 volts DC, which was the output of the fuel cell.

The gas output of the alane vessel 24 was plumbed into the fill line of the hydrogen tank 28. Hydrogen gas from the alane fuel vessel 24 refilled the hydrogen tank 28, thus extending the flight time. The heater controller 16 communicated via Bluetooth™ to an iPad™ and provided status information concerning hydrogen tank 28 pressure and power supplied to the heater. The heater controller 16 was programmed to use the pressure signal from the hydrogen tank 28 as feedback to control heater power. A thermocouple 22 (FIG. 11A) was placed at the top of the second alane puck and its signal was used as a heater cutoff signal once the temperature of the top alane puck reached 200° C. At that temperature, all the hydrogen has been liberated from the alane and heating is no longer of any use.

During the flight (FIG. 14), a person monitored the system status displayed on the iPad™ and reported values to the UAV pilot. The system worked as designed and the hydrogen from the alane extended the flight by 5.3 minutes. An increase in flight time of 5.2 minutes was expected. The flight was successful. The hydrogen depleted alane pucks are illustrated in FIG. 15. As shown, the alane pucks maintained shape throughout and after the flight.

FIG. 16 provides plots of changing hydrogen tank pressure and fuel cell power during the flight and includes several notations referring to various points during the flight.

### Example 2

In this example, a larger alane vessel and UAV platform were utilized and sustained flight was demonstrated using only hydrogen gas stored within the alane fuel material. Ultimately, 154 g of alane powered the flight for 412 s and used 46.60% of the available on-board hydrogen. Comparably, a full 2.14 L alane vessel that uses 100% of the available hydrogen should add 5,702 s (1 hr, 35 min, 2 s) of flight time under similar conditions.

The hydrogen fuel cell was purchased from a third party and was engineered specifically for UAV applications. The hydrogen fuel cell was designed to fit on a UAV alongside a compressed hydrogen cylinder. The UAV platform was designed specifically for the extended flight time application. Noteworthy design features include a high thrust to weight ratio, low current draw, and large size. The aircraft fell within the Federal Aviation Administration (FAA) small UAV category and had ample room to carry the alane/hydrogen system payload (24.5 lbs. all-up weight).

Preliminary testing of the 800 W hydrogen fuel cell provided an efficiency of 34.65%. After several reconditioning cycles, efficiency peaked at 41.48%. At the fuel cell's peak efficiency, 13.44 Wh per gram of energy from the hydrogen was expected to be utilized, which is a magnitude of 50 times higher than the energy density of lithium-ion batteries.

The hydrogen system was composed of the alane fuel vessel, ceramic heater, heater controller, compressed hydrogen tank, and hydrogen fuel cell. For this example, the ceramic heater consumed 100 W of power from an external battery. The alane vessel had a volume of 2.14 L and could hold up to 10 pucks of alane as described in Example 1. The high grade alane was composed of up to 10 wt. % hydrogen. 10 pucks of alane had a total mass of approximately 1 kg and could release up to 100 g of hydrogen gas. Due to the current cost and availability of alane, 0.15 kg of high grade alane was provided for the test.

Bench tests of the hydrogen system were conducted before flight tests. Several preliminary tests were run without alane to verify fuel cell consistency and maintain the limited alane supply. The system was tested independently of the UAV's motors using a Transistor Devices™ DLVP-50-120-1500 electrical load bank. Data was taken with a National Instruments™ NI CompactDAQ for data acquisition, and custom LabVIEW™ program for analysis.

The load bank was connected to the output of the fuel cell and set to “constant current” mode. Constant current mode used the nominal fuel cell output voltage while letting the user set current draw, simulating a UAV in continuous hover. Fuel cell output voltage (V), fuel cell output current (A), hydrogen tank pressure (psi), and heater (or alane puck) temperature (° C.) was monitored during each bench test. Power output (W) was calculated in real time and displayed alongside the raw data in the LabVIEW™ window.

Fuel cell testing with no alane vessel or connection to the UAV (FIG. 17) was run prior to alane tests. The 1.47 L hydrogen cylinder was filled to around 1,200 psi for each test, which was an adequate pressure to record several minutes of data and different power loads over various tests. The fuel cell was reconditioned several times to increase efficiency after sitting for an extended period without use. A custom program for reconditioning the fuel cell was used in which the fuel cell experienced a cycle of short bursts to its maximum output.

Various fuel cell tests were run with differing power outputs. Output voltage was kept constant while current was manually changed to vary the load on the fuel cell. Every trial was run until the tank pressure reached the fuel cell cutoff pressure of approximately 72 psi. For all bench tests, the LabVIEW™ logs were saved to an excel file to be formatted later.

During the alane tests and for the first flight test, two alane pucks were placed in the fuel vessel with a ceramic heater in between that contacted both puck surfaces. A hole was manually drilled in the bottom puck for the heater electrical connection. The vessel was loaded in the following order: base insulation, heater connector, first alane puck, ceramic heater, second alane puck, and insulation for the remaining space. A thermocouple was placed through one of the ports in the top until it contacted the second puck's outside surface. FIG. 18 displays the basic setup of the bottom half of the container to show the bottom puck and heater orientation.

The vessel was then sealed, purged of atmospheric gasses, leak checked, and pressurized with hydrogen gas to approximately 250 psi. Any hydrogen gas surrounding the alane acted as a buffer and provided more flight time.

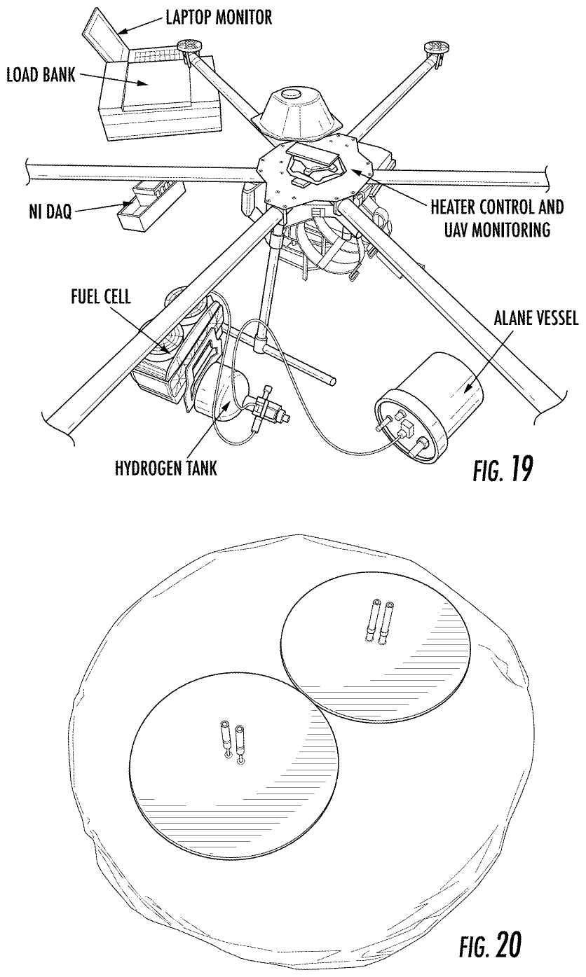

The UAV control systems were monitored during the bench tests with alane (FIG. 19) to ensure all electronics (excluding motors) were functioning properly. Similar to the fuel cell only tests, various power outputs were tested. The alane vessel was connected to the hydrogen tank pressure regulator via a one-way check valve. When the hydrogen tank pressure reached the alane vessel's fill pressure (˜250 psi), the valve opened and both tanks equilibrated. The heater was turned on as the pressure regulator approached 300 psi to allow the alane ample time to reach 80° C. before the fuel cell cutoff pressure was reached.

On the day of a first test flight all battery voltages, alane vessel pressure, and hydrogen tank pressure were checked. The hydrogen tank and alane vessel were pressurized to 4,300 psi and 250 psi respectively. During this test, the fuel cell output voltage, hydrogen regulator pressure, and alane temperature signal were all monitored via a radio control transmitter. Telemetry hardware was used to display all voltage signals on the controller screen. The heater was controlled manually via a radio controlled switch.

A normal flight was conducted, and all pre-flight checklist items were performed. The UAV was placed into ‘loiter’ mode after takeoff, which locks the GPS position and barometer altitude for a stable hover. The UAV was left in ‘loiter’ mode for the remainder of the flight. The heater was manually switched cony when the tank pressure reached approximately 300 psi, before the check valve opened. The heater was switched back ‘off’ before landing to conclude the test. Data was recorded by the automatic data log in the fuel cell and analyzed in Microsoft Excel. The first flight was successful, but the alane did not reach a sufficient temperature. The alane needed more heat to release hydrogen at a high enough rate for sustained flight (i.e. producing gas at a faster rate than is consumed by the fuel cell under a constant load).

A few changes were made before the second flight. A temperature controller was added to control the heater using alane surface temperature as the input. The controller also provided real time data to an iPad™ via Bluetooth™ connection. The resolution of the temperature controller was much higher than the resolution of the radio controlled telemetry module used in the first flight. Additionally, a second heater was added in parallel to the first for better surface area coverage as shown in FIG. 20. 154 g (2 pucks) of alane was used for this test.

The procedure from the first flight test was repeated for the second flight test. However, the heaters were activated automatically by the temperature controller. FIG. 21 illustrates the UAV in flight with the full alane system payload.

After all bench and flight tests involving alane, the vessel was placed into a glovebox and the pucks were carefully removed. A Thermogravimetric Analysis (TGA) check was performed by taking material samples from different locations on the surface of each puck. The TGA measured the remaining hydrogen weight-percent in each alane sample. This check was used to determine how much hydrogen, if any, was left in the alane pucks after the full test.

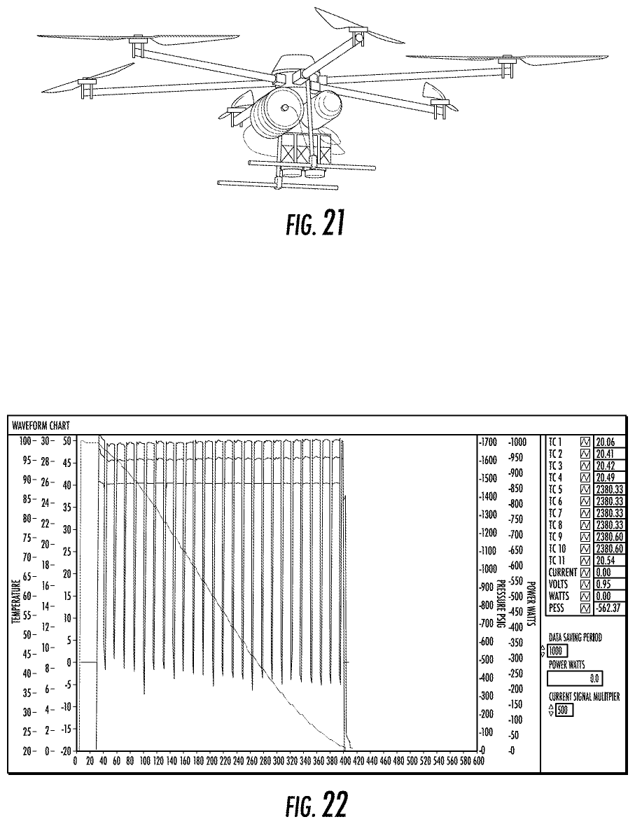

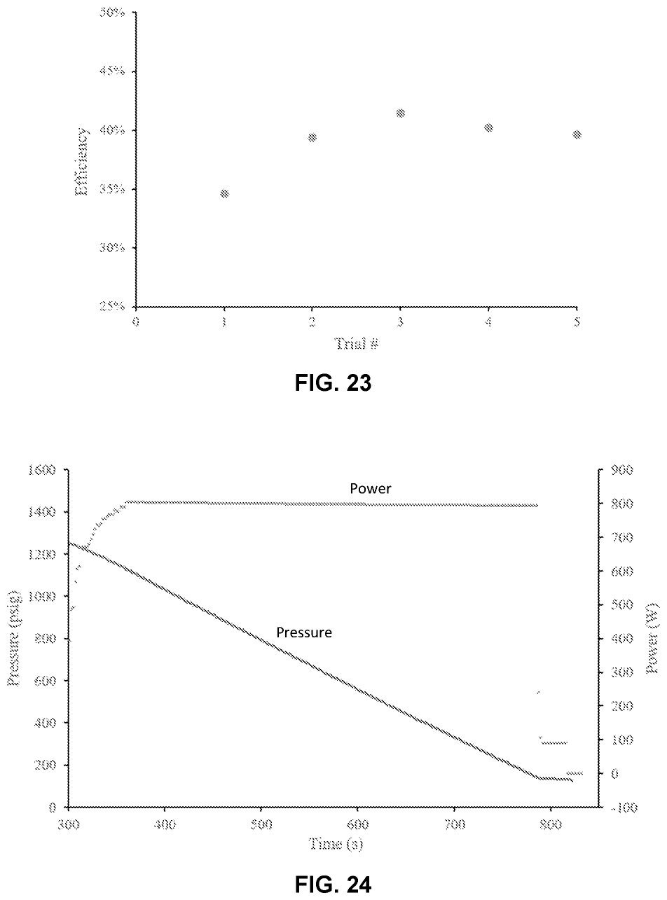

FIG. 22 illustrates a fuel cell reconditioning cycle in the LabVIEW™ program window. No alane or compressed alane vessel gas was used during the reconditioning tests. The fuel cell was only fed by the hydrogen cylinder. The efficiency change over a single reconditioning cycle was not discernible, as the pressure rate of change did not vary dramatically. The fuel cell reconditioning cycle must run several times to increase efficiency, as suggested by the manufacturer. The fuel cell efficiency change is evident when evaluating efficiency over multiple cycles (FIG. 23).

The efficiency was estimated with a linear regression of the pressure data for each period of constant power (in this case, within 790-800 W) and the input H₂ specific energy of 32.4 Wh/g. Two reconditioning cycles were run between each trial in FIG. 23. Over all trials, the efficiency increased up to 41.48% and settled at approximately 40%.

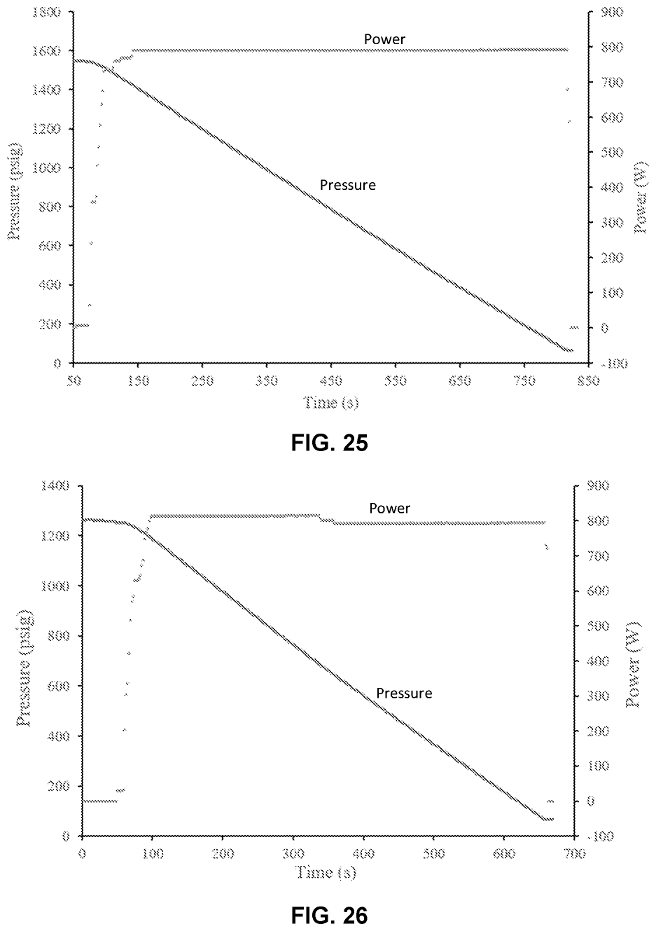

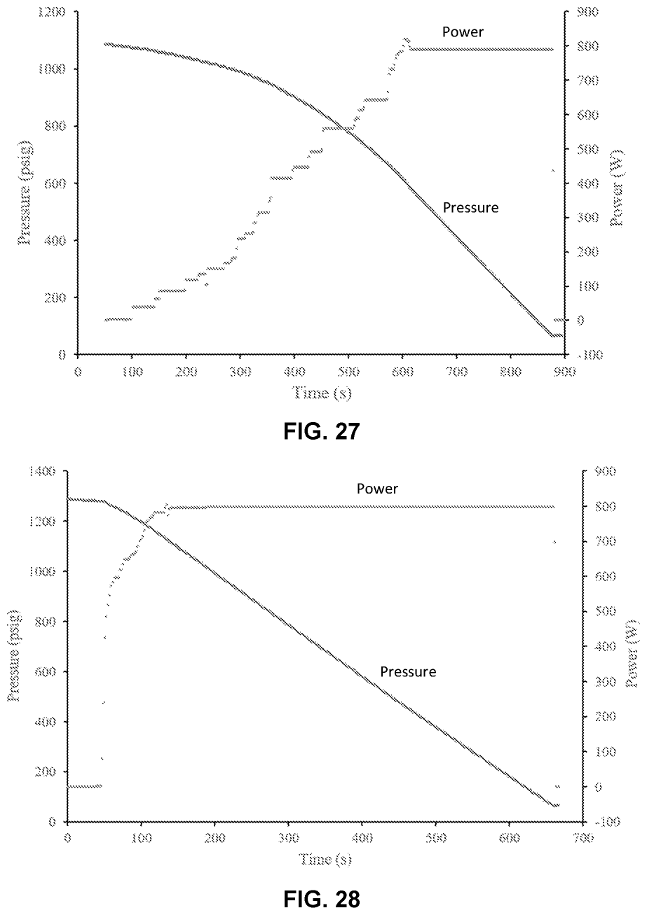

The test data from all trial datapoints in FIG. 23 are provided in FIG. 24 through FIG. 28. The efficiencies were as follows: Trial 1 (FIG. 24), from time t=360 to 786 s average power 798.6 W, Eff 34.65%; Trial 2 (FIG. 25), from time t=146 to 816 s average power 790.1 W, Eff 39.43%. Trial 3 (FIG. 26), from time t=101 to 331 s average power 793.0 W, Eff 41.48%. Trial 4 (FIG. 27), from time t=618 to 874 s average power 790.7 W, Eff 40.23%. Trial 5 (FIG. 28), from time t=169 to 659 s average power 797.8 W, Eff 39.64%.

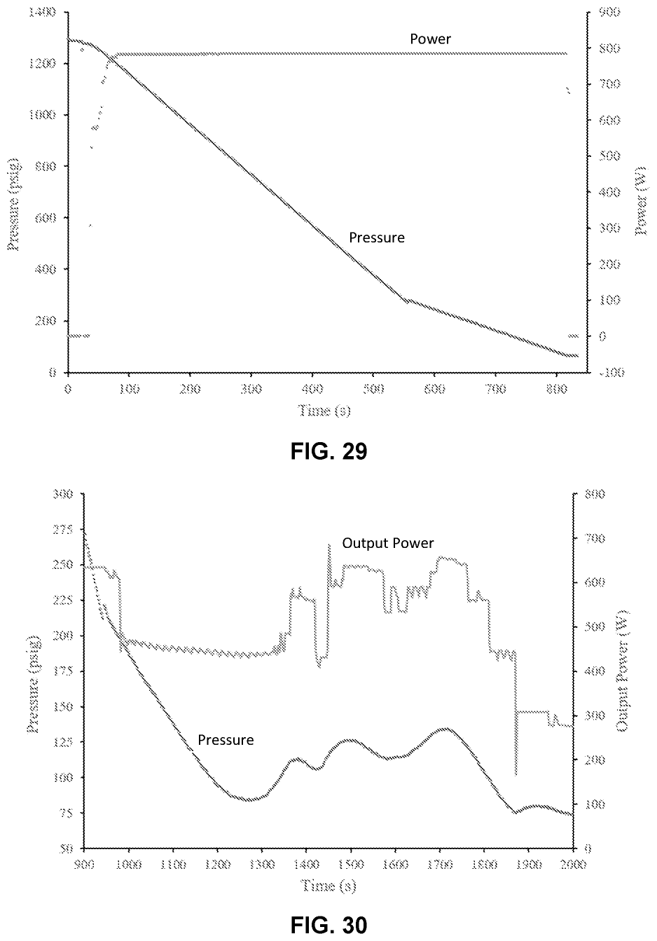

The bench test to verify functionality of the alane vessel check valve is presented in FIG. 29.

Based on the pressure curve, the check valve opened when the tank pressure reached 273 psig and remained open until the conclusion of the test. The total gas volume increased to 3.61 L (1.47 L cylinder and 2.14 L alane vessel) when the valve opened, and the pressure rate decreased as expected. The check valve never presented any problems and worked well during all remaining tests.

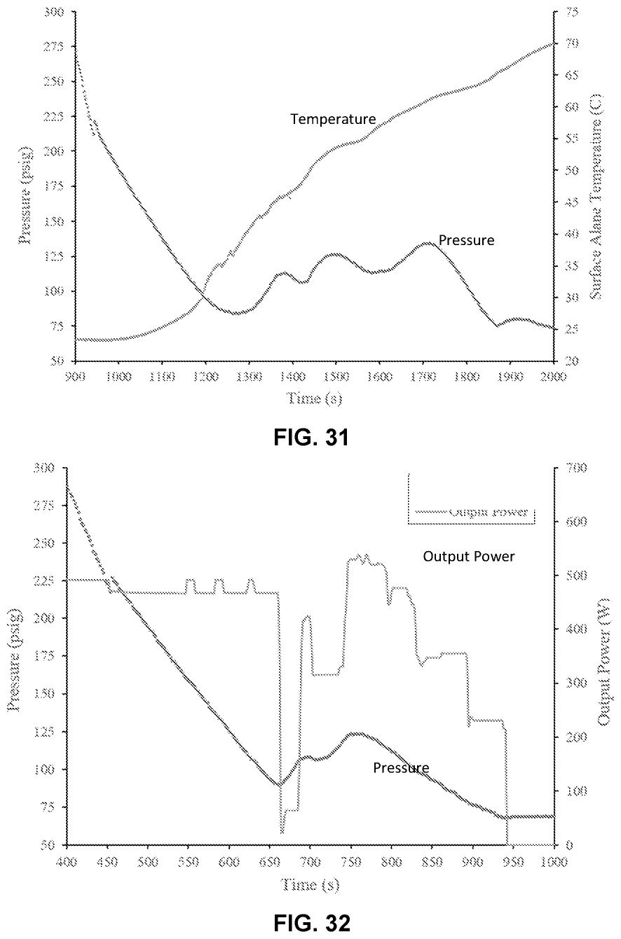

The first alane test results are shown in FIG. 30 and FIG. 31. Alane with less than 10 wt. % H₂ was used for this study. Gas usage data from only the hydrogen cylinder has been omitted to clearly display the alane's effect. The time axis starts at 900 s and the check valve opened at 943 s.

A pressure increase was observed within the alane vessel during the first bench test. The pressure was manually maintained by changing the load cell current draw and turning the heater on/off. The change in output power can be seen in FIG. 30, while the inconsistent rate of temperature increase from the heater is seen in FIG. 31. The output power in FIG. 30 suggests that the fuel cell had an inconsistent output voltage (current was controlled and constant). A gas mixture may have been introduced while filling the tank. The process used for purging, filling, and leak testing the alane vessel with hydrogen was carefully followed in the remaining tests.

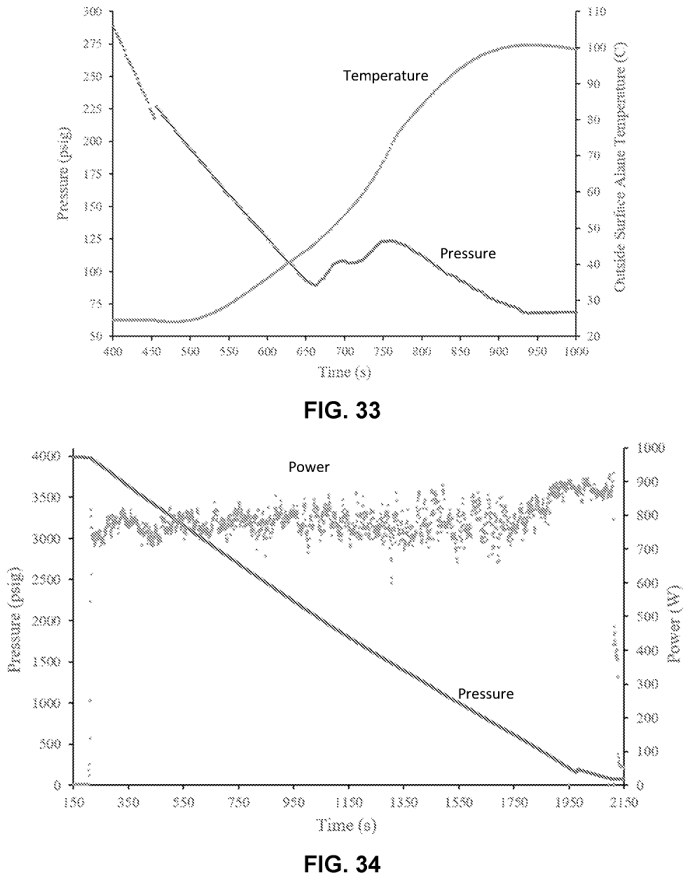

A second bench test was carried out. Results are shown in FIG. 32 and FIG. 33. Although there was no control loop, the main goal of the test was attained as the alane produced a pressure increase within the system.

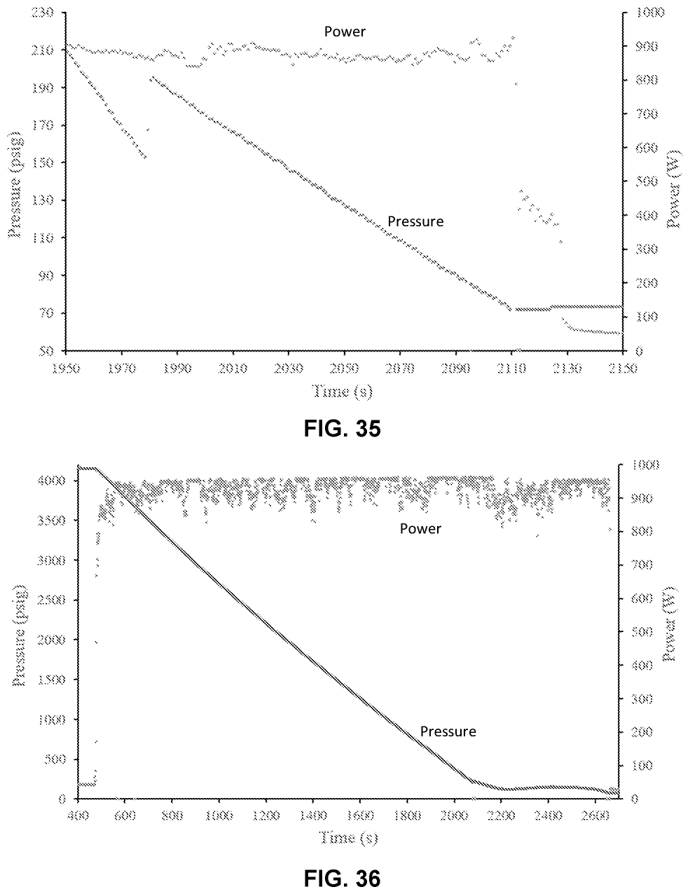

FIG. 34 and FIG. 35 illustrate the hydrogen gas pressure and fuel cell output power from the first flight test. The UAV takeoff weight was 24.5 lbs.

The takeoff pressure was 3,979 psig at 211 s and the fuel cell shutoff pressure was 75 psig at 2,107 s (FIG. 34). The hydrogen gas powered flight lasted 1,896 s (31 min, 36 s). The check valve for the alane vessel opened at 1,981 s (196 psig). The flight time was extended by the compressed hydrogen surrounding the alane (an increased volume of gas). However, the pressure decrease remained linear, suggesting no hydrogen gas was introduced into the system from alane. A TGA analysis from the alane pucks confirmed a high hydrogen weight percent was still present.

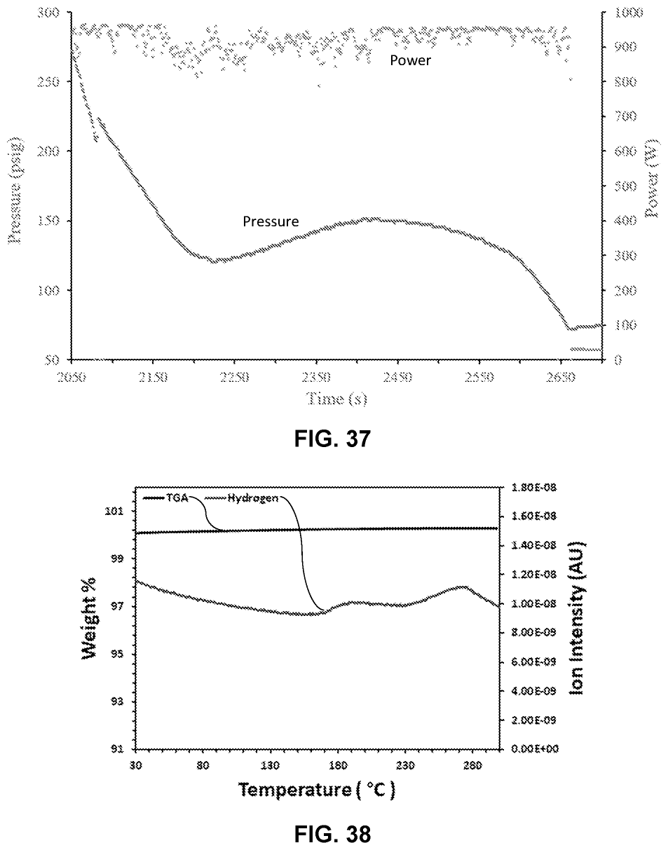

FIG. 36 and FIG. 37 display the hydrogen gas pressure and fuel cell output power from the second flight test.

The takeoff pressure was 4,145 psig at 668 s and the fuel cell shutoff pressure was 72 psig at 2,660 s (FIG. 36). The check valve for the alane vessel opened at 2,082 s (210 psig). The first effect of alane on the system is observed at approximately 2,180 s. The rate of gas used by the fuel cell began to decrease at 2,180 s. Pressure data after the check valve opened was extrapolated and suggests the fuel cell shut off would have been 2,248 s without the effect of alane. The estimated flight time on hydrogen gas alone with no alane, is approximately 1,580 s (26 min, 20 s).

The total flight time, from takeoff to fuel cell shut off, was 1,992 s (33 min, 12 s). Alane extended the flight by 412 s (6 min, 52 s). While running on hydrogen gas before alane usage, the fuel cell lost pressure at a rate of −0.9048 psig/s. Assuming a gas temperature of 40° C. at the pressure transducer and volume of 3.61 L, the estimated molar flow rate was −0.0087 molts (assuming an ideal gas, PV=nRT). To maintain a hover, the alane must release gas at a rate of 0.0087 mol/s.

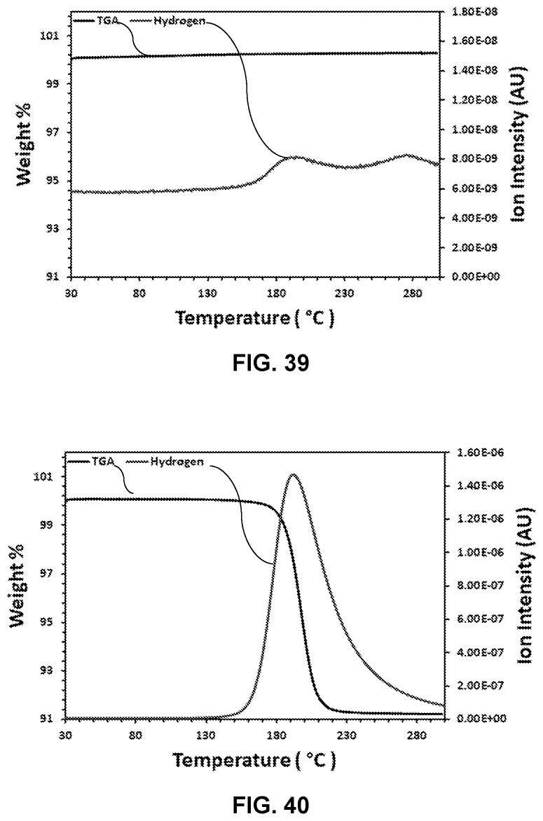

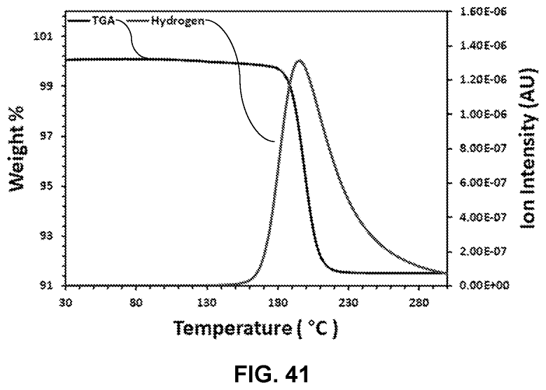

154 g of alane was used with 10 wt. % H₂, therefore a total 15.4 g (7.64 mol) of H₂ was available in this flight. Theoretically, 7.64 mol of H₂ will provide an additional 878 s (14 min, 38 s) of flight time. Only 3.56 mol of H₂, or 46.60% of the available H₂, was expelled during the test. FIG. 38, FIG. 39, FIG. 40, and FIG. 41 show TGA analyses of several samples from the spent alane pucks. The data for FIG. 38 was obtained from the first alane puck, data taken from the center of the puck on the heater side. The data for FIG. 39 was obtained from the second alane puck, data taken from the center of the puck on the heater side. The data for FIG. 40 was obtained from the first alane puck, data taken from the outside edge of the puck, on the heater side. The data for FIG. 40 was obtained from the second alane puck, data taken from the outside edge of the puck, on the heater side.

FIG. 38 and FIG. 39 verify that hydrogen was not present in the center of the heater side of both pucks. The solid TGA line remains constant with temperature, indicating no change in material mass fraction. However, FIG. 40 and FIG. 41 verify that not all hydrogen was released from the outside edges of both pucks. The change in sample weight percent is about 8% for pucks 1 & 2, which is the remaining hydrogen weight percent at both sample locations.

The tests successfully demonstrated sustained flight using only the energy stored within the metal hydride. The Alane released hydrogen gas into the system at a higher rate than the fuel cell requires for sustained flight of the custom UAV. 154 g of Alane extended the flight 412 s and used 46.60% of the available hydrogen on-board. Comparably, a full Alane vessel that uses 100% of the available H₂ should add 5,702 s (1 hr, 35 min, 2 s) of flight time under similar conditions. The inference, not all H₂ was separated from the Alane pucks, was further supported by the TGA results.

Three batteries were on board the UAV for the second flight test. One battery to power the fuel cell (and is recharged by the fuel cell), one to power the heater & temperature controller, and one backup battery running in parallel with the fuel cell output. Ultimately, the backup battery and heater/temperature controller batteries will be removed for reduced weight and independence from the conventional power source.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A hydrogen fuel cell system comprising:
a fuel vessel configured to regain a solid hydrogen storage material;
a hydrogen storage tank in fluid communication with the fuel vessel;
a pressure sensor configured to monitor a hydrogen pressure within the hydrogen storage tank;
a heater configured to heat the solid hydrogen storage material
a heater controller in communication with the pressure sensor and the heater such that the hydrogen pressure within the hydrogen storage tank is a controlling factor for the operation of the heater; and
a hydrogen fuel cell in fluid communication with the hydrogen storage tank.

2. The system of claim 1, wherein the fuel vessel comprises multiple pressure-isolated segments.

3. The system of claim 1, wherein the heater is a ceramic heater.

4. The system of claim 1, comprising a plurality of heaters in communication with the heater controller.

5. The system of claim 4, wherein the plurality of heaters are independently controlled by the heater controller.

6. The system of claim 1, the solid hydrogen storage material comprising alane.

7. The system of claim 1, wherein the solid hydrogen storage material is in the form of a plurality of particles bonded or sintered to one another.

8. The system of claim 1, wherein the solid hydrogen storage material is in the form of a metal foam.

9. The system of claim 1, wherein the hydrogen fuel cell is configured to provide power to the heater controller.

10. A vehicle comprising the hydrogen fuel cell system of claim 1.

11. The vehicle of claim 10, wherein the vehicle is an unmanned aerial vehicle.

12. A method for powering an electric motor comprising:
retaining a solid hydrogen storage material within a fuel vessel;
transmitting information regarding a pressure within a hydrogen storage tank to a heater controller;
based upon the pressure, the heater controller powering a heater in thermal communication with the solid hydrogen storage material, wherein upon the powering of the heater, hydrogen is released from the solid hydrogen storage material and flows to the hydrogen storage tank;
controlling a flow of hydrogen from the hydrogen storage tank to a hydrogen fuel cell; and
powering the electric motor by use of a current flow generated in the fuel cell in response to the hydrogen flow.

13. The method of claim 12, wherein the solid hydrogen storage material comprises alane.

14. The method of claim 12, further comprising monitoring the temperature of the hydrogen storage material.

15. The method of claim 12, wherein the hydrogen storage tank initially is charged with hydrogen, the heater controller powering the heater following flow of a portion of the initially charged hydrogen to the hydrogen fuel cell.

16. The method of claim 12, wherein the solid hydrogen storage material is retained in multiple separated pressure-isolated segments of the fuel vessel, the method comprising independently heating the solid hydrogen storage material retained within each pressure-isolated segment.

17. The method of claim 12, further comprising monitoring the temperature of the solid hydrogen storage material.

18. The method of claim 17, further comprising removing power from the heater upon the temperature of the solid hydrogen storage material reaching an upper limit.

19. The method of claim 12, the electric motor providing power to propellers of an unmanned aerial vehicle.

20. The method of claim 19, further comprising powering the heater controller by use of the current flow generated in the fuel cell in response to the hydrogen flow.
